(19) United States
(12) Patent Application Publication
(10) Pub. No.: US 2020/0282883 A1
(43) Pub. Date: Sep. 10, 2020

(54) SEAT HEATING DEVICE

(71) Applicant: DENSO CORPORATION, Kariya-city (JP)

(72) Inventors: Masafumi KAWASHIMA, Kariya-city (JP); Shuji ITO, Kariya-city (JP); Hironobu MURAKAMI, Kariya-city (JP); Takahisa FUJII, Kariya-city (JP)

(21) Appl. No.: 16/883,663

(22) Filed: May 26, 2020

Related U.S. Application Data
(63) Continuation of application No. PCT/JP2018/039030, filed on Oct. 19, 2018.

(30) Foreign Application Priority Data
Nov. 28, 2017 (JP) 2017-228113

(51) Int. Cl. B60N 2/56

(52) U.S. Cl. CPC B60N 2/5685; B60N 2/5657

(57) ABSTRACT

A seat heating device is disposed in a seat pad supporting a seated person and supplies heat to a seat surface. The seat heating device includes a pair of electrodes and a heating body. The pair of electrodes face each other in a thickness direction of the seat pad. The heating body is formed of a pressurized conductor and is disposed between the pair of electrodes. The heating body generates heat when pressurized and energized.

### CROSS REFERENCE TO RELATED APPLICATIONS

This application is a continuation application of international Patent Application No. PCT/JP2018/039030 filed on Oct. 19, 2018, which designated the U.S. and claims the benefit of priority from Japanese Patent Application No. 2017-228113 filed on Nov. 28, 2017. The entire disclosure of all of the above applications are incorporated herein by reference.

### TECHNICAL FIELD

The present disclosure relates to a seat heating device.

### BACKGROUND ART

A heating device typically includes a base member, a heating body, a seating detector, and a controller.

The heating body is disposed on the base member made of an elastomer. The heating body includes a heat generating layer including an elastomer and a conductive material, and a pair of heat generating layer wires that include an elastomer and a conductive material and that are connected to the heat generating layer. The capacitance-type seating detector includes (i) a pair of electrode layers that are disposed on the base member and include an elastomer and a conductive material, (ii) an elastomer dielectric layer interposed between the pair of electrode layers, and (iii) a pair of seating wires that include a conductive material and that are connected to the pair of electrode layers. The controller controls the heating body based on signals from the seating detector.

### SUMMARY

According to one aspect of the present disclosure, a seat heating device is disposed in a seat pad supporting a seated person and supplies heat to a seat surface. The seat heating device includes a pair of electrodes and a heating body. The pair of electrodes face each other in a thickness direction of the seat pad. The heating body is formed of a pressurized conductor and is disposed between the pair of electrodes. The heating body generates heat when pressurized and energized.

### BRIEF DESCRIPTION OF DRAWINGS

The above and other objects, features and advantages of the present disclosure will become more apparent from the following detailed description made with reference to the accompanying drawings.

FIG. 1 is a diagram schematically showing an overall configuration of a heating device according to a first embodiment.

FIG. 2 is an exploded perspective view showing a seat pad shown in FIG. 1.

### DESCRIPTION OF EMBODIMENTS

Hereinafter, embodiments of the present disclosure will be described with reference to the drawings. In the following embodiments, the same or equivalent parts are denoted by the same reference numerals as each other, and explanations will be provided to the same reference numerals for simplifying descriptions.

To begin with, a relevant technology will be described first only for understanding the embodiments as described below.

For example, in the configuration of the above-described device, it is necessary to provide the heating body and the seating detector on a single sheet member. Further, it is necessary to provide a control unit for controlling the heating body based on signals from the seating detector. Therefore, in such a device, the device configuration may be complicated, and thus the device cost may be increased.

The present disclosure has been made in view of the circumstances exemplified above. That is, the present disclosure provides, for example, a seat heating device that minimizes the complexity of the device configuration.

As described above, according to one aspect of the present disclosure, a seat heating device is disposed in a seat pad supporting a seated person and supplies heat to a seat surface. The seat heating device includes a pair of electrodes and a heating body. The pair of electrodes face each other in a thickness direction of the seat pad. The heating body is formed of a pressurized conductor and is disposed between the pair of electrodes. The heating body generates heat when pressurized and energized.

In such a configuration, the heating body is pressed in the thickness direction of the seat pad by the load from the seat pad supporting an occupant. Then, the heating body formed of a pressurized conductor is in an energizable state where a current can flow through the heating body. That is, it is possible to conduct electricity from one of the pair of electrodes to the other of the pair of electrodes via the heating body. The heating body that turns to be such an energizable state due to the pressure can generate heat when energized.

In such a configuration, by forming the heating body with a pressurized conductor, the single heating body has both a heat generating function and a seat detecting function. Therefore, it is possible to simplify the device configuration.

### Embodiments

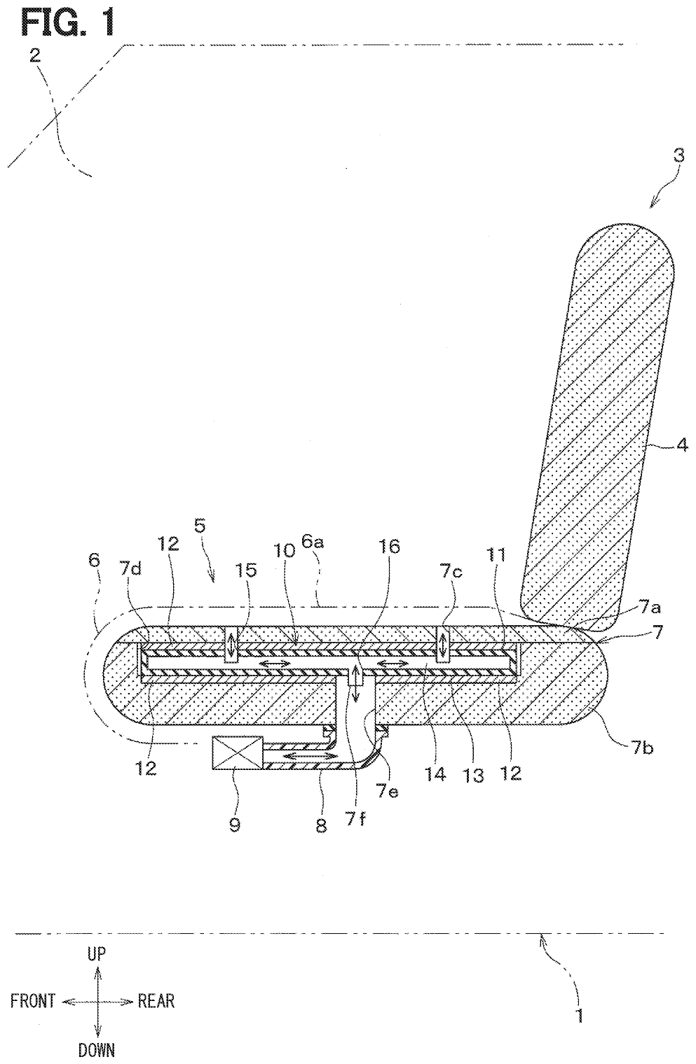

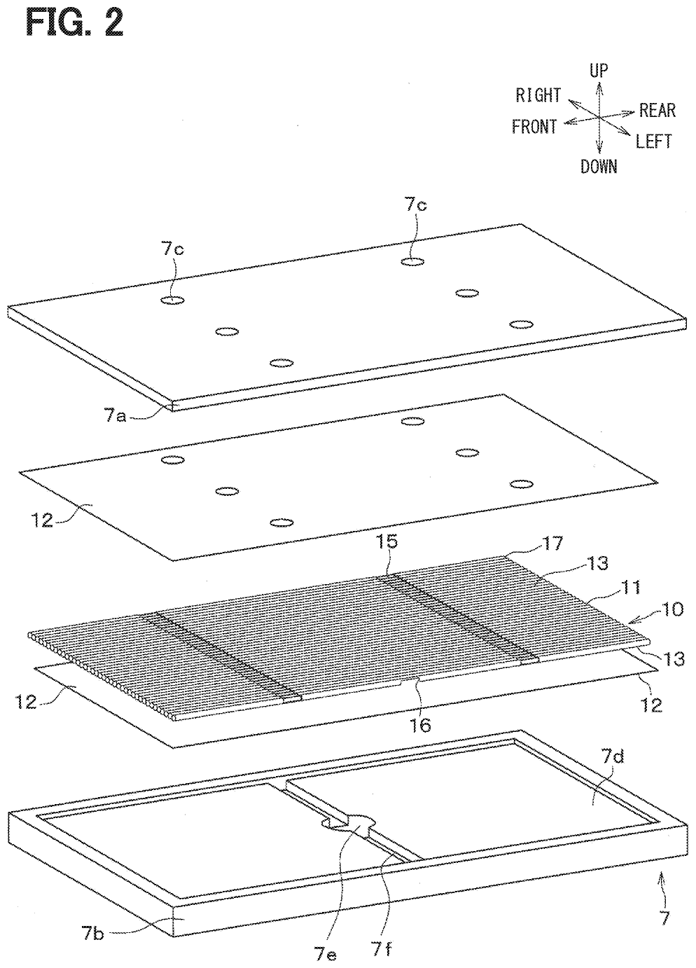

Hereinafter, an embodiment will be described with reference to FIGS. 1 and 2. Note that if various modifications applicable to one embodiment are inserted in a series of description of the one embodiment, it would make understanding the embodiment difficult. Therefore, those modifications will be collectively described subsequent to description of the embodiment.

(Entire Configuration)

Referring to FIG. 1, a seat 3 is installed in a cabin 2 of a vehicle 1. In the present embodiment, the seat 3 is an automobile seat of the vehicle 1 which is an automobile.

Hereinafter, for convenience of description, the front, rear, left, right, upper, and lower directions in the configuration of the present embodiment are defined as indicated by arrows in the drawings. The directions are provided only for convenience in order to simply describe the configuration of the embodiment. Therefore, “the lower direction” does not necessarily mean the direction in gravity. However, typically, when the vehicle 1 is stable on a horizontal plane, “the lower direction” is substantially the same as the direction in gravity. Similarly, the left-right direction is substantially the same as the vehicle width direction. However, the left-right direction does not necessarily mean the vehicle width direction. The same applies to the front-rear direction.

The seat 3 includes a backrest 4, a seat surface portion 5, and a cover 6. The backrest 4 extends obliquely upward from a rear end of the seat surface portion 5 and supports an upper body of an occupant from a back side thereof when the occupant sits on the seat 3. The seat surface portion 5 is provided to support buttocks and thighs of the occupant from a lower side thereof when the occupant sits on the seat 3.

The backrest 4 and the seat surface portion 5 have an outer surface that serves as the cover 6. For simplifying purposes in FIG. 1, a portion of the cover 6 corresponding to the backrest 4 is omitted in the present embodiment. The cover 6 may be formed of a breathable fabric, for example, a cloth, natural leather with perforations, or synthetic leather with perforations. an outer surface of the seat surface portion 5 that faces the buttocks and thighs of the occupant when the occupant sits on the seat 3. In other words, the seat surface 6a is a portion of the surface of the cover 6 corresponding to the seat surface portion 5.

The seat surface portion 5 has the cover 6 and a seat pad 7. That is, in the present embodiment, the seat pad 7 is a part of the seat 3 installed in the cabin 2 of the vehicle 1.

The seat pad 7 is formed of a foamed polyurethane resin or the like having a high cushioning property so as to favorably support a seated person, that is, an occupant sitting on the seat 3. In the present embodiment, the seat pad 7 has a two-layer structure in which an upper pad 7a and a lower pad 7b are stacked with each other. The upper pad 7a and the lower pad 7b are made of the same material having the same characteristics. The “characteristics” include, for example, a hardness measured in accordance with an industrial standard such as JIS K 6400.

The upper pad 7a is arranged between the cover 6 and the lower pad 7b. In the upper pad 7a, a plurality of seat-side passages 7c through which air smoothly flows are formed in a vertical direction, that is, along the thickness direction of the upper pad 7a. “The air smoothly flows” means that a large flow resistance does not generate against the airflow flowing through the seat-side passage 7c. Hereinafter, the same applies to portions other than the seat-side passage 7c. More specifically, the seat-side passage 7c is a through-hole passing through the upper pad 7a in the thickness direction, and is open toward the cover 6, that is, the seat surface 6a.

The lower pad 7b is arranged below the upper pad 7a. In the present embodiment, the lower pad 7b is provided with a housing 7d. The housing 7d is a concave that opens toward the upper pad 7a, and is formed in a substantially rectangular shape in a plan view. In this specification, the “plan view” refers to viewing an object from above.

In the lower pad 7b, an air source passage 7e through which an air smoothly flows is formed in the vertical direction, that is, along the thickness direction of the lower pad 7b. Note that the thickness direction of the lower pad 7b is the same as the thickness direction of the upper pad 7a, and also the same as the thickness direction of the entire seat pad 7. The air source passage 7e is a through hole that passes through the lower pad 7b in the thickness direction, and opens at a substantially central portion of the housing 7d in a plan view.

A groove 7f through which an airflow flows is formed along the left-right direction substantially at the center in the front-rear direction of the housing 7d. The groove 7f is a concave portion that opens toward the upper pad 7a. The groove 7f is connected to the duct 8 via the air source passage 7e.

The duct 8 is a tubular member and connects an airflow generator 9 and the seat heating device 10. In the present embodiment, the duct 8 is arranged below the seat 3. The airflow generator 9 is, for example, a blower disposed below the seat 3. More specifically, the airflow generator is a blower unit. Alternatively, the airflow generator 9 may be, for example, an air conditioner mounted in the vehicle 1.

(Configuration of the Seat Heating Device)

The seat heating device 10 is disposed in the seat pad 7 in the seat surface portion 5 to supply an airflow and heat to the seat surface 6a. Specifically, the seat heating device 10 includes a heating body 11 and a pair of electrodes 12. Hereinafter, the configuration of each part of the seat heating device 10 will be described with reference to FIGS. 1 and 2.

As shown in FIG. 2, the heating body 11 is formed into a film shape and has a rectangular planar shape to be housed in the housing 7d. The “planar shape” refers to an outline of the film shape member when viewed in a direction perpendicular to a horizontal plan on which the film shape member is mounted so that the thickness direction of the film shape member is perpendicular to the horizontal plan. That is, the planar shape of the heating body 11 means the outline of the heating body 11 in a plan view.

The heating body 11 has a pair of sheet surfaces 13 each having a rectangular planar shape. The sheet surface 13 is a surface in parallel with the horizontal surface of the heating body 11 when the heating body 11 is placed on a horizontal plane. That is, the sheet surface 13 is a surface that constitutes a top surface and a bottom surface.

The heating body 11 is formed of a pressurized conductor that generates heat when pressurized and energized. Specifically, the heating body 11 is made of a pressurized conductive elastomer such as a pressurized conductive rubber and is integrally, seamlessly formed.

In the present embodiment, the heating body 11 is non-conductive under a non-pressurized state and turns to be conductive by selectively reducing resistance in a pressurized region of the heating body 11 in an in-plane direction. The in-plane direction is a direction that intersects the thickness direction of the seat pad 7. The in-plane direction is a direction parallel to the horizontal plane when the heating body 11 is placed on the horizontal plane such that the sheet surface 13 is in parallel with the horizontal plane. That is, when the three-dimensional shape of the heating body 11 is regarded as a thin plate shape, the in-plane direction is an arbitrary direction on a main surface of the thin plate shape that is perpendicular to the thickness direction of the thin plate shape.

The heating body 11 is disposed between the pair of electrodes 12. The two electrodes 12 are arranged to face each other in the vertical direction, that is, in the thickness direction of the seat pad 7. The heating body 11 is configured to generate heat when pressurized and energized by electrically connecting one of the pair of electrodes 12 to a positive electrode of a power source (not shown) and the other of the pair of electrodes 12 to a negative electrode of the power source.

Each of the electrodes 12 is a conductive sheet having a rectangular planar shape and extending in the in-plane direction. The electrode 12 is made of a good conductor such as copper. Specifically, the electrode 12 is formed into a plate shape facing the sheet surface 13. The electrode 12 has a planar shape that is substantially the same as the planar shape of the heating body 11. Each of the pair of electrodes 12 is joined to the pair of sheet surfaces 13 of the heating body 11.

As shown in FIG. 1, the heating body 11 defines an air passage 14 through which an air flows smoothly. In the present embodiment, the air passage 14 extends along the front-rear direction so that an air mainly flows in the front-rear direction. Both ends of the air passage 14 in the front-rear direction are closed.

Further, the heating body 11 has a plurality of air holes 15 through which an air flows smoothly. Each of the air holes 15 is a through hole that opens on the seat surface 13 and is in communication with the air passage 14. The each of air holes 15 is open toward the seat surface 6a when the heating body 11 is disposed in the seat pad 7 of the seat surface portion 5. That is, a space outside the heating body 11 and the air passage 14 are in communication with each other via the air holes 15. Further, the air holes 15 are located at positions corresponding to the seat-side passages 7c in the front-rear direction. That is, each of the air holes 15 is arranged to face the corresponding seat-side passage 7c in the front-rear direction.

Further, the heating body 11 has a communication hole 16 through which an air flows smoothly. The communication hole 16 is a through hole that opens at one the sheet surfaces 13 opposite to the other of the sheet surfaces 13 where the air holes 15 formed. The communication hole 16 is in communication with the air passage 14. The communication hole 16 is located at a position corresponding to the groove 7f in the front-rear direction to be in communication with the groove 7f when the heating body 11 is disposed in the seat pad 7 in the seat surface portion 5. That is, the communication hole 16 faces the groove 7f.

In the present embodiment, the heating body 11 is formed by arranging a plurality of air tubes 17 in parallel with each other. The plurality of air tubes 17 are made of pressurized conductive elastomers. Each of the air tubes 17 is a tube having the air passage 14 therein and therefore is formed into a cylindrical shape. Each of the plurality of air tubes 17 extends in the front-rear direction. The plurality of air tubes 17 are arranged in the left-right direction. That is, the heating body 11 has a structure in which the plurality of air passages 14 extending in the front-rear direction are arranged in parallel with each other. Further, the heating body 11 is configured such that an energizing direction is the same as the extending direction of the air tubes 17.

Specifically, in this embodiment, the plurality of air tubes 17 are integrated by connecting each pair of the two air tubes 17 that are adjacent in the left-right direction to each other. For example, the plurality of air tubes 17 may be seamlessly integrated with each other. For this reason, the seat surface 13 has a shape in which a plurality of semi-columnar surfaces are arranged in parallel and are smoothly connected to each other. Further, in each of the air tubes 17, a cutout is formed at the same position in the front-rear direction as other cutouts of the other air tubes 17 to define altogether the air hole 15. Further, in each of the air tubes 17, a cutout is formed at the same position in the front-rear direction as other cutouts of the other air tubes 17 to define altogether the communication hole 16.

(Operation)

Hereinafter, an outline of an operation of the seat heating device 10 according to the present embodiment will be described together with advantages achieved by the configuration of the present embodiment with reference to FIGS. 1 and 2.

When an occupant sits on the seat 3, the heating body 11 is pressed in the thickness direction of the seat pad 7 by the load from the seat pad 7 supporting the occupant. Then, the heating body 11 formed of the pressurized conductor becomes a conductive state where a current can flow in the pressurized region in the in-plane direction due to a seating pressure. That is, it is possible to conduct electricity from one of the pair of electrodes 12 to the other of the pair of electrodes 12 via the pressurized region in the heating body 11.

For example, an air may be blown from the airflow source toward the seat heating device 10. In this case, an airflow in a blowing direction is supplied from the airflow source 9 to the seat heating device 10 via the duct 8. Then, due to the airflow, an airflow is generated in which air flows into the air passages 14 in the heating body 11 through the air source passage 7e, the groove 7f, and the communication hole 16.

As a result, an airflow is generated in which air flows out of the heating body 11 from the air passages 14 through the air holes 15. That is, airflows are discharged from the air holes 15 toward the seat surface 6a. The airflows discharged from the air holes 15 toward the seat surface 6a passes through the seat-side passages 7c and the cover 6 having air permeability. Then, the airflow reaches the cabin 2. In this way, air is blown to the seated person.

In another mode, an air is sucked in by the airflow source 9. In this case, an airflow toward the airflow source 9 may be generated from the seat heating device 10. That is, an airflow in a drawing direction is supplied from the airflow source 9 to the seat heating device 10 via the duct 8. Due to the airflow, an airflow is generated to flow out of the air passages 14 in the heating body 11 via the communication hole 16, the groove 7f, and the air passage 7e. That is, air is sucked from the air passages 14 in the heating body 11.

As a result, an airflow is generated to flow into the air passages 14 in the heating body 11 through the seat-side passages 7c and the air holes 15. Then, a negative pressure is generated in the seat-side passages 7c. Accordingly, the air around the seat surface 6a passes through the permeable cover 6 and is sucked into the heating body 11. In this way, by sucking the air between the seated person and the seat 3, it is possible to effectively eliminate stuffiness in the seated portion.

In addition, through the pair of electrodes 12, the pressurized region in the heating body 11 is energized. Then, in the pressurized region, the heating body 11 generates heat through energization. Therefore, a heating operation for the seated person is performed. The heating operation may be performed at a different timing from the blowing operation or the drawing operation, or at the same timing as the blowing operation or the drawing operation. In particular, when the blowing operation and the heating operation are performed at the same time, an air in the air passages 14 is heated by energization of the heating body 11. By supplying such a heated air to the occupant through the air holes 15, heating of the occupant can be effectively realized together with radiant heat generated from the heating body 11.

As described above, in the configuration of the present embodiment, the seat heating device 10 includes the heating body 11 and the pair of electrodes 12. The two electrodes 12 are arranged to face each other in the thickness direction of the seat pad 7. The heating body 11 is disposed between the pair of electrodes 12. The heating body 11 is formed of a pressurized conductor that generates heat when pressurized and energized.

In such a configuration, by forming the heating body 11 with a pressurized conductor, the single heating body 11 has both a heat generating function and a seat detecting function. That is, it is possible by the function of the heat generating unit 11 itself to reduce a power consumption due to unnecessary heat generation when no occupant sits on the seat 3 and to perform the heat generating function when an occupant sits on the seat 3. Therefore, it is possible to simplify the configuration of the seat heating device 10.

Further, in the present embodiment, the heating body 11 is formed of a pressurized conductive elastomer. Therefore, it is possible to realize the single heating body 11 having the heating function and the seat detecting function with a simple configuration.

Further, in the present embodiment, the heating body 11 is formed in a film shape. Further, the heating body 11 is configured so that the pressurized region in the in-plane direction can be selectively energized. In such a configuration, the film-like heating body 11 can be selectively energized in the pressurized region in the in-plane direction. The pressurized area in the in-plane direction may vary according to a seating state of the occupant. Therefore, it is possible to set a heat generating region in the film-like heating body 11 in accordance with the seating state with a simple configuration.

Further, in the present embodiment, the heating body 11 includes the air passages 14 and the air holes 15. The air passages 14 are formed in the heating body 11. The air holes 15 are in communication with the air passages 14. The each of air holes 15 is open toward the seat surface 6a when the heating body 11 is disposed in the seat pad 7.

In such a configuration, the heating body 11 has a ventilation function by discharging or drawing air through the air holes 15. Further, the heating body 11 generates heat at the pressurized region in the in-plane direction when energized. In such a configuration, the single heating body 11 can perform the ventilation function, the seat detecting function, and the heat generating function by the heat generating portion 11 itself generating heat when energized. That is, the ventilation function, the seat detecting function, and the heat generating function are integrated.

If a two-layer structure where a sheet heater and the heating body 11 are disposed between the seat surface 6a and the seat pad 7 is adopted, an airflow resistance would increase due to the existence of the sheet heater. On the contrary, in the configuration of the present embodiment, the ventilation function and the heating function are realized by the single heating body 11, and thus the above-described increase in the airflow resistance can be avoided.

As described above, according to the configuration, the seat heating device 10 can have a good ventilation property and a heat generating property with a simplified structure. From such a viewpoint, the seat heating device 10 may be referred to as a “seat air conditioner,” a “seat blower,” or a “seat airflow generator” having a heating function.

Further, in the present embodiment, the heating body 11 having a ventilation function is formed of a pressurized conductive elastomer. In such a configuration, the heating body 11 is configured by forming the heating body 11 having a ventilation function from a pressurized conductive elastomer. Therefore, the single heating body 11 in which the ventilation function, the seat detecting function, and the heat generating function are well integrated can be realized at a low cost.

Further, in the configuration of the present embodiment, the heating body 11 is formed by arranging in parallel the plurality of air tubes 17 each formed in a tube shape and defining the air passage 14 therein. More specifically, in this embodiment, the heating body 11 has a structure in which the plurality of air tubes 17 are integrated by connecting each pair of the two air tubes 17 that are adjacent in the left-right direction to each other.

In such a configuration, the heating body 11 has a structure in which the plurality of air passages 14 defined in the inside space of the air tube 17 are arranged in parallel with each other. Therefore, it is possible to realize the single heating body 11 in which the ventilation function, the seat detecting function, and the heat generating function are well integrated with a simple configuration.

In the present embodiment, the seat pad 7 constitutes a part of the seat 3 installed in the cabin 2 of the vehicle 1. In such a configuration, by attaching the heating body 11 to the seat pad 7 that configures a part of the seat 3 installed in the cabin 2 of the vehicle 1, the heating body 11 can supply an airflow and/or heat to an occupant of the vehicle 1. Therefore, it is possible to provide the ventilation function and the heat generating function in a seat of a vehicle such as an automobile while minimizing the complexity of the device configuration.

(Modifications)

The present disclosure is not necessarily limited to the above embodiment. Thus, it is possible to appropriately change the above-described embodiment. Representative modifications will be described below. In the following description of the modifications, parts different from the above embodiment will be mainly described. In addition, in the above-described embodiment and the modifications, the same reference numerals are given to the same or equivalent parts. Therefore, in the description of the following modifications, regarding components having the same reference numerals as the components of the above-described embodiment, the description in the above-described embodiment can be appropriately cited unless there is a technical inconsistency or a specific additional explanation.

The concepts of the front, rear, left, right, up, and down directions in the description and the drawings are set only for simply describing the configuration of the embodiment. Accordingly, the present disclosure is not necessarily limited to such a directional concept.

For example, as shown in FIG. 1, when the seat 3 is installed “forward,” the left-right direction is the same or substantially the same as the vehicle width direction. On the contrary, if the seat 3 is installed “sideways,” the front-rear direction is the same or substantially the same as the vehicle width direction. If the seat 3 is installed “backward,” the front-back direction is reversed. The same applies to the modifications described below.

The structure of the seat 3 is not particularly limited to the above-described configuration. For example, the seat 3 may be a front seat or a rear seat. The backrest 4 may be adjustable or non-adjustable in reclining angles. The backrest 4 may be equipped with a headrest that supports a head of a seated person. Alternatively, the seat 3 may not have the backrest 4.

The cover 6 may be integrated with the outer surface of the seat pad 7.

In the above embodiment, the heating body 11 is mounted in the seat pad 7 by being housed in the housing 7d formed in the lower pad 7b. However, the present disclosure is not necessarily limited to such a configuration. For example, the heating body 11 may be housed in the upper pad 7a.

Alternatively, the heating body 11 may be arranged between the cover 6 and the seat pad 7. In this case, the seat pad 7 may have an integral structure that is not vertically separated.

In the above embodiment, the heating body 11 is formed by arranging the plurality of air tubes 17 in parallel to be integrally formed with each other. However, the present disclosure is not necessarily limited to such a configuration. For example, the heating body 11 may be formed by forming a plurality of air passages 14 in a single plate-shaped member.

The airflow generator 9 may be a blower disposed close to the seat 3. More specifically, the airflow generator 3 may be a blower unit. In this case, it can be understood that the seat heating device 10 includes the heating body 11 and the airflow generator 9 that supplies an airflow to the heating body 11.

The flow direction of the airflow in the air passage 14 and the energizing direction, i.e., the current flow direction in the heating body 11, may be parallel as in the above-described embodiment or, alternatively, may cross each other.

In the above embodiment, the heating body 11 has a ventilation function by having the air passages 14 therein. However, the present disclosure is not necessarily limited to such a configuration. For example, the heating body 11 may be a simple seat heater having no ventilation function.

In the above-described embodiment and each of the modifications, the seat heating device 10 is disposed in the seat surface portion 5. However, the present disclosure is not necessarily limited to such a configuration. That is, the seat heating device 10 may be disposed in the backrest 4 instead of the seat surface portion 5 or together with the seat surface portion 5. When the seat heating device 10 is disposed in the backrest 4, the backrest 4 may be configured in the same manner as the seat surface 5 in the above embodiment and each of the modifications. Therefore, in order to avoid redundant description, the illustration and description of the configuration of the backrest 4 when the seat heating device 10 is disposed in the backrest 4 will be omitted in this specification.

The material constitutes the heating body 11 is not necessarily limited to the elastomer as long as it has a pressurized conductivity. Also, there is no particular limitation on the pressurized conductivity of the heating body 11 as long as it has an insulating property when no pressure is applied to the heating body 11.

For example, regardless of the weight of an occupant, it is preferable to have an ON-OFF load-resistance characteristic in order to make the entire seat area, that is, the pressurized region, a good heat generating area. The ON-OFF load-resistance characteristic refers to a characteristic in which the resistance rapidly decreases when a relatively low load is applied, and thereafter, even if the load is increased, decrease in the resistance value is almost saturated.

However, the present disclosure is not necessarily limited to such a configuration. That is, the pressurized conductivity of the heating body 11 may have a load-resistance characteristic such that the resistance value substantially, linearly decreases as the load value increases.

In the above description, a plurality of elements formed integrally with each other with no seam may be formed by bonding separate members together. Similarly, a plurality of elements formed by bonding separate members together may be formed integrally with each other with no seam.

In the above description, a plurality of elements formed of the same material may be formed of different materials. Similarly, a plurality of elements formed of different materials may be formed of the same material.

The modifications are also not necessarily limited to the above examples. Further, a plurality of modifications may be combined together. Furthermore, all or a part of the above-described embodiments and all or a part of the modifications may be combined with each other.

The constituent element(s) of each of the above embodiments and the above modifications is/are not necessarily essential unless it is specifically stated that the constituent element(s) is/are essential in the above embodiments, or unless the constituent element(s) is/are obviously essential in principle. In addition, in the case where the number of the constituent element(s), the value, the amount, the range, and/or the like is specified, the present disclosure is not necessarily limited to the number of the constituent element(s), the value, the amount, and/or the like specified in the embodiment unless the number of the constituent element(s), the value, the amount, and/or the like is indicated as essential or is obviously essential in view of the principle. Similarly, in the case where the shape, the direction, the positional relationship, and/or the like of the constituent element(s) is specified, the present disclosure is not necessarily limited to the shape, the direction, the positional relationship, and/or the like unless the shape, the direction, the positional relationship, and/or the like is/are indicated as essential or is/are obviously essential in principle.

(Overview)

Hereinafter, various aspects of the present disclosure, which are indicated by part or all of the disclosure according to the above-described embodiment and modified examples, will be described.

In a first aspect, the seat heating device includes the heating body and the pair of electrodes. The two electrodes are arranged to face each other in the thickness direction of the seat pad. The heating body is disposed between the pair of electrodes. The heating body is formed of a pressurized conductor that generates heat when pressurized and energized.

In such a configuration, by forming the heating body with a pressurized conductor, the single heating body has both a heat generating function and a seat detecting function. Therefore, it is possible to simplify the structure of the seat heating device.

In a second aspect, the heating body is formed of a pressurized conductive elastomer. Therefore, it is possible to realize the single heating body having a heating function and a seat detection function with a simple configuration.

In a third aspect, the heating body is formed into a film shape. Further, the heating body is configured so that the pressurized region in the in-plane direction can be selectively energized. The in-plane direction is a direction that intersects the thickness direction of the seat pad. In such a configuration, the film-like heating body can be selectively energized in the pressurized region in the in-plane direction. The pressurized area in the in-plane direction may vary according to a seating state of the occupant. Therefore, it is possible to set a heat generating region in the film-like heating body in accordance with the seating state with a simple configuration.

In a fourth aspect, the heating body has the air passage and the air hole. The air passage is formed in the heating body. The air holes are in communication with the air passage. The each of air holes is open toward the seat surface when the heating body is disposed in the seat pad.

In such a configuration, the film-shaped heating body has a ventilation function by discharging or drawing air through the air holes. Further, the heating body generates heat when pressurized and energized. That is, the ventilation function, the seat detecting function, and the heat generating function are integrated by the single heating body. Thus, according to the configuration, the seat heating device can have a good ventilation property and a heat generating property with a simplified structure.

In a fifth aspect, the heating body is formed by arranging in parallel the plurality of air tubes each formed in a tube shape and defining the air passage therein. In such a configuration, the heating body has a structure in which the plurality of air passages defined in the space of the air tubes are arranged in parallel with each other. Therefore, it is possible to realize the single heating body in which the ventilation function, the seat detecting function, and the heat generating function are well integrated with a simple configuration.

In a sixth aspect, the seat pad constitutes the seat installed in the cabin of the vehicle. That is, by attaching the heating body to the seat pad that configures the seat installed in the cabin of the vehicle, the heating body can supply heat to an occupant of the vehicle. Therefore, it is possible to provide a heat generating function in a seat of a vehicle such as an automobile while minimizing the complexity of the device.

1. A seat heating device that is disposed in a seat pad supporting a seated person and that supplies heat to a seat surface, the seat heating device comprising:
a pair of electrodes that face each other in a thickness direction of the seat pad; and
a heating body that is formed of a pressurized conductor and is disposed between the pair of electrodes, wherein
the heating body generates heat when pressurized and energized.

2. The seat heating device according to claim 1, wherein
the heating body is made of a pressurized conductive elastomer.

3. The seat heating device according to claim 1, wherein
the heating body is formed into a film-like shape and includes a pressurized region that extends in an in-plane direction perpendicular to the thickness direction of the heating body, and
the pressurized region is configured to be selectively energized.

4. The seat heating device according to claim 3, wherein
the heating body includes an air passage that is formed inside the heating body and an air hole that is in communication with the air passage and opens toward the seat surface when the seat heating device is disposed in the seat surface.

5. The seat heating device according to claim 4, wherein
the heating body is formed by arranging a plurality of air tubes in parallel with each other, and
each of the plurality of air tubes is formed in a tubular shape and defines the air passage therein.

6. The seat heating device according to claim 1, wherein
the seat pad constitutes a part of a seat installed in a cabin of the vehicle.
